(19) United States
(12) Patent Application Publication
(10) Pub. No.: US 2012/0082184 A1
(43) Pub. Date: Apr. 5, 2012

(54) PHYSIOLOGICAL SIGNAL SENSING DEVICE, CONTAINING DEVICE AND METHOD FOR TRANSPORTING A PROTECTIVE FILM

(75) Inventors: Chun Liang LU, New Taipei City (TW); Chih-Hsien Huang, New Taipei City (TW); Yi-Hsin Huang, New Taipei City (TW); Chao-Wang Chen, Taipei City (TW)

(73) Assignee: TAIDOC TECHNOLOGY CORPORATION

(21) Appl. No.: 13/249,227

(22) Filed: Sep. 29, 2011

(30) Foreign Application Priority Data
Oct. 5, 2010 (TW) 099133944

(51) Int. Cl. G01K 1/08

(52) U.S. Cl. 374/209; 374/E01.012

(57) ABSTRACT

A physiological signal sensing device, a containing device and a method for transporting a protective film are provided. The physiological sensing device includes a sensing module, a transporter, and a driving assembly. The sensing module is used for sensing vital signals. The transporter is used for transporting a protective film. The driving assembly includes a first structural member, a second structural member and a third structural member. One of the second and the third structural members selectively connects to the transporting device depending on the rotation direction of the first structural member for driving the transporter to transport the protective film from a starting site to an ending site.

### BACKGROUND OF THE INVENTION

1. Field of the Invention

The present invention relates to a device and a method for transporting a protective film, and particularly relates to a containing device or a physiological signal sensing device with a driving assembly to drive a transporter to transport the protective film.

2. Description of the Related Art

Kinds of electrical thermometer have been developed such as a pen-shaped body thermometer, a pacifier-shaped thermometer, or an IR thermometer.

Before using an ear thermometer such as IR ear thermometer, users often use a protective cap, such as a cone-shaped one, to cover a probe of the ear thermometer to provide hygienic protection. After covering a cap over the probe head, user put the probe into the ear canal of the one who are being measured to receive infrared radiation and then a signal indicating the patient's body temperature is shown. After measuring, the used protective cap will be thrown away. Then, before the next measurement, a new cap will be used to cover the probe for the next people who are being measured to prevent cross infection by directing contacting the probe.

However it is still risky to contact polluted sources by directly touching the used protective caps by hand.

Refer to FIG. 1, FIG. 1 is an ear thermometer with a protective-cap cassette in prior art. The protective-cap cassette (91) is used for containing few protective caps (910) and engaged within a handle portion (901) of a housing. The protective cap (910) comprises a solid plastic base (912) to hold a film (913) which can be extended.

The ear thermometer (90) consists of a sensing probe (901), two wheals (902, 903) and a hook portion (904). During the operation, the sensing probe (901) is moved to an opening (92) so as to drive wheels (902, 903) to rotate and then to drive the hook portion (904) to hook a protective cap (910) to the opening (92). When the sensing probe (901) retracts back, the rotation of wheels (902, 903) will have the hook portion (904) turn back to its original position. Until the next time when the sensing probe (901) is moved forward to the opening (92) does the hook portion (904) be driven to hook a new protective cap (910).

However, this ear thermometer with a hook portion (904) and wheels (902, 903) can pick a protective cap just when the sensing probe (902) is moved toward the opening (92). Hence, the length of the moving path of the sensing module must be the same as or longer than the moving path of the protective cap so that the protective cap (910) can be fully moved to the opening (92) in the right position by the hook portion (904). This contributes to the volume of ear thermometer being very large. What's worse, the volume of the cassette (91) and protective caps (910) are large and they are made by more complicate procedures. Whereby this kind of ear thermometer can only contain few caps but the size is pretty large.

### SUMMARY OF THE INVENTION

In order to solve the above noted conventional problems, one aspect of the present invention is to provide a physiological signal sensing device, a containing device and a containing device for containing protective film that achieve for transporting a protective film to a right position at an opening by both moving a sensing module forward to the opening and rearwards away from the opening.

The present invention relates to a physiological signal sensing device which can transport a protective film to a right position at an opening by both moving a sensing module forward to the opening and rearwards away from the opening

The present invention relates to a containing device which can transport a protective film to a right position at an opening by both moving a container forward to the opening and rearwards away from the opening.

The present invention relates to a containing device for containing a protective film, which is adapted for the containing device or the physiological signal sensing device described above.

The present invention relates to a method for transporting a protective film, which is adapted for the containing device or the physiological signal sensing device described above.

In an aspect of the present invention, a physiological signal sensing device comprises a sensing module, a transporter and a driving assembly. The sensing module is used for sensing vital signal(s). The transporter is used for transporting a protective film from a starting site to an ending site. A driving assembly includes a first structural member, a second structural member and a third structural member. The first structural member connects with the sensing module. One of the second structural member and the third structural member selectively connects to the transporter depending on a rotation direction of the first structural member. In addition, the first structural member, the second structural member and the third structural member can be driven to rotate by one another. When the sensing module drives the first structural member to rotate in a first direction, such as counterclockwise direction, the first structural member drives the second structural member to connect with the transporter and drives the third structural member to disconnect with the transporter, and the rotation of the second structural member drives the transporter to transport the protective film from the starting site to the ending site. When the sensing module drives the first structural member to rotate in a second direction, such as clockwise direction, the first structural member drives the third structural member to connect with the transporter and drives the second structural member to disconnect with the transporter, and the rotation of the third structural member will drive the transporter to transport the protective film from the starting site to the ending site.

In an embodiment of the present invention, the physiological signal sensing device further includes a follower connected between the sensing module and the driving assembly for driving the driving assembly to act by the motion of the sensing module.

The sensing module is movably moved in the physiological signal sensing device by a force.

In an embodiment of the present invention, the physiological signal sensing device further includes a controller disposed on the sensing module and extended out from the physiological signal sensing device for providing a holding site for users to move the sensing module.

In an embodiment of the present invention, the physiological signal sensing device further includes a fastening connecting with the sensing module for fixing the protective film at an opening.

In an embodiment of the present invention, the physiological signal sensing device further includes a resistant connecting with the sensing module for forming a resisting force against the motion of the sensing module.

In an embodiment of the present invention, the physiological signal sensing device further includes an immobilizing assembly connected between the sensing module and the housing. After the sensing module is moved till the protective film is stretched over the sensing module, the immobilizing assembly is fixed at a predetermined position so as to maintain a situation that the protective film being stretched over the sensing module.

The immobilizing assembly may be designed as a coupling assembly with a male member and a female member such as a protrusion and a corresponding depression disposed separately at the sensing module and a predetermined site of the physiological signal sensing device.

In an embodiment of the present invention, the physiological signal sensing device further includes a protective-film containing assembly. The protective-film containing assembly is engaged with the transporter for containing the protective film.

In another aspect in accordance with the present invention, a containing device is provided. The containing device includes a container, a transporter, and a driving assembly.

The container is used for providing a containing space. The transporter is used for transporting a protective film from a starting site to an ending site. The driving assembly includes a first structural member, a second structural member and a third structural member. The first structural member connects with the container. One of the second structural member and the third structural member selectively connects to the transporter depending on a rotation direction of the first structural member. The first structural member, the second structural member and the third structural member can be driven to rotate by one another. When the container drives the first structural member to rotate in a first direction, such as counterclockwise direction, the first structural member drives the second structural member to connect with the transporter and drives the third structural member to disconnect with the transporter, and the rotation of the second structural member drives the transporter to transport the protective film from the starting site to the ending site. When the container drives the first structural member to rotate in a second direction, such as clockwise direction, the first structural member drives the third structural member to connect with the transporter and drives the second structural member to disconnect with the transporter, and the rotation of the third structural member can drive the transporter to transport the protective film from the starting site to the ending site.

The containing device can contain any apparatus that can be engaged within the container, such as a sensing module, or a hard structure member depending on the design.

In an embodiment of the present invention, the containing device further comprises a follower. The follower is connected between the container and the driving assembly for having the driving assembly be driven by the motion of the container.

The container is movably moved in the containing device by a force.

In an embodiment of the present invention, the containing device further includes a controller disposed on the container and extended out from the containing device for providing a holding site for users to move the container.

In an embodiment of the present invention, the containing device further includes a fastening connecting with the container for fixing the protective film at an opening properly.

In an embodiment of the present invention, the containing device further comprises a resistant. The resistant is engaged with the container. When the container is moved to a predetermined site, the resistant is driven by the container so as to form a resisting force against the motion of the container.

In an embodiment of present invention, the containing device further includes an immobilizing assembly. The immobilizing assembly is connected between the container and the containing device. After the protective film is stretched over the container, the immobilizing assembly is fixed at a predetermined position so as to maintain a situation that the area being stretched over the container.

Preferably, the above immobilizing assembly may be designed as a coupling assembly with a male member and a female member such as a protrusion and a corresponding depression disposed separately at the container and a predetermined site of the containing device.

In an embodiment of the present invention, the containing device further includes a protective-film containing assembly for containing the protective-film. The protective-film containing assembly is engaged with the transporter for containing the protective film.

Preferably, the physiological signal sensing device or the containing device further includes a connecting member connecting with the first structural member, the second structural member and the third structural member so as to have the connection of each axle center of the first structural member, the second structural member and the third structural member form as a triangular shape.

In preferred embodiments of the present invention, the physiological signal sensing device or the containing device further includes a rotating member connected between the first structural member and the third structural member, or connected between the third structural member and the transporter for having the transporting direction of the transporter be the same.

In an embodiment of present invention, the resistant can be spring, damper or those providing a resisting force.

In an embodiment of the present invention, the fastening can be designed such as a hard structure. In a preferred embodiment, the fastening can be designed as an elastic structure, for example, a spring structure, disposed and surrounded the sensing module or the container. The spring can both provide a resisting force against the motion of the sensing module or the container and fix an area of a protective film at the opening.

In an embodiment of the present invention, the sensing module can be designed as needed such as detachable type or fixed type engaged in the physiological signal sensing device or the containing device.

In an embodiment of the present invention, the transporter can be designed as needed such as detachable type or fixed type engaged in the physiological signal sensing device or the containing device.

In one another aspect of the present invention, a containing device is provided. The containing device is used for containing a protective film and adapted for a physiological signal sensing device. The physiological signal sensing device includes a driving assembly, a transporter and a sensing module. The containing device includes a containing portion and an accepting portion. The containing device is connected with the transporter. More specifically, the accepting portion is connected with the transporter. The containing portion is used for containing a protective film. The accepting portion is used for accepting the protective film from the containing portion. The driving assembly includes a first structural member, a second structural member and a third structural member. The first structural member connects with the container. One of the second structural member and the third structural member selectively connects to the transporter depending on a rotation direction of the first structural member. The first structural member, the second structural member and the third structural member can be driven to rotate by one another. When the sensing module drives the first structural member to rotate in a first direction, such as counterclockwise direction, the first structural member drives the second structural member to connect with the transporter and drives the third structural member to disconnect with the transporter, and the rotation of the second structural member drives the transporter to transport the protective film from the containing portion to the accepting portion. When the sensing module drives the first structural member to rotate in a second direction, such as clockwise direction, the first structural member drives the third structural member to connect with the transporter and drives the second structural member to disconnect with the transporter, and the rotation of the third structural member can drive the transporter to transport the protective film from the containing portion to the accepting portion.

In yet another aspect of the present invention, a method for transporting a protective film is provided. The method is adapted for a transporter. The transporter is engaged with a first structural member, a second structural member, and a third structural member. The method including driving the first structural member to rotate in a first direction, such as counterclockwise direction, so as to drive the second structural member to connect with the transporter and drive the third structural member to disconnect with the transporter, and the rotation of the second structural member can drive the transporter to transport the protective film from a starting site to an ending site, and the first structural member, the second structural member and the third structural member can be driven to rotate by one another, and driving the first structural member to rotate in a second direction, such as clockwise direction, so as to drive the third structural member to connect with the transporter and drive the second structural member to disconnect with the transporter, and the rotation of said second structural member can drive the transporter to transport said protective film from the starting site to the ending site.

In still another aspect of the present invention, another method for transporting a protective film is provided. The method is adapted for a physiological signal sensing device. The physiological signal sensing device includes a sensing module, a transporter, and a driving assembly. The sensing module is used for sensing vital signal(s). The transporter is used for transporting a protective film. The driving assembly includes a first structural member, a second structural member and a third structural member. The method includes two steps, which are driving the first structural member to rotate in a counterclockwise direction by the sensing module so as to drive the second structural member to connect with the transporter and drive the third structural member to disconnect with the transporter, and the rotation of the second structural member can drive the transporter to transport the protective film from a starting site to an ending site, and the first structural member, the second structural member and the third structural member can be driven to rotate by one another; and driving the first structural member to rotate in a clockwise direction by the sensing module so as to drive the third structural member to connect with the transporter and drive the second structural member to disconnect with the transporter, and the rotation of the third structural member can drive the transporter to transport the protective film from the starting site to the ending site.

In an embodiment of the present invention, the protective film has good tractility and stretchable. It can be made of such as polyethylene, polyvinyl chloride or other material with good tractility.

In an embodiment of the present invention, the first, the second and the third structural member may be designed as gear or wheel structure.

In an embodiment of present invention, the sensing module is designed for sensing vital signal. The vital signal can be such as body temperature, forehead temperature, ear temperature, dryness of skin or sonographic image signals.

As described above, the present invention provides a physiological signal sensing device or a containing device which can transport a protective film from a starting site to an ending site perfectly by moving a sensing module or a container forward to the opening or rearwards away from an opening. Whereby, it can be prevented from contacting the protective film directly by hands and second using of the used protective film. In addition, the problem of the ear thermometer as described in the prior art that the moving path of the sensing probe must as long as or loner than the moving path of the protective cap in order to replace the protective cap to the right position can be solved.

More exemplary embodiments and advantages of the present invention may be ascertained by reviewing the present disclosure and the accompanying drawing. It is intended that the description and embodiments with reference to the accompanying drawing to be considered as exemplary only.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The following drawings form part of the present specification and are included to further demonstrate certain aspects of the present invention. The invention may be better understood by reference to one or more of these drawings in combination with the detailed description of specific embodiments presented herein.

FIG. 1 is a view of a disclosed ear thermometer and a protective cap cassette thereof in the prior art;

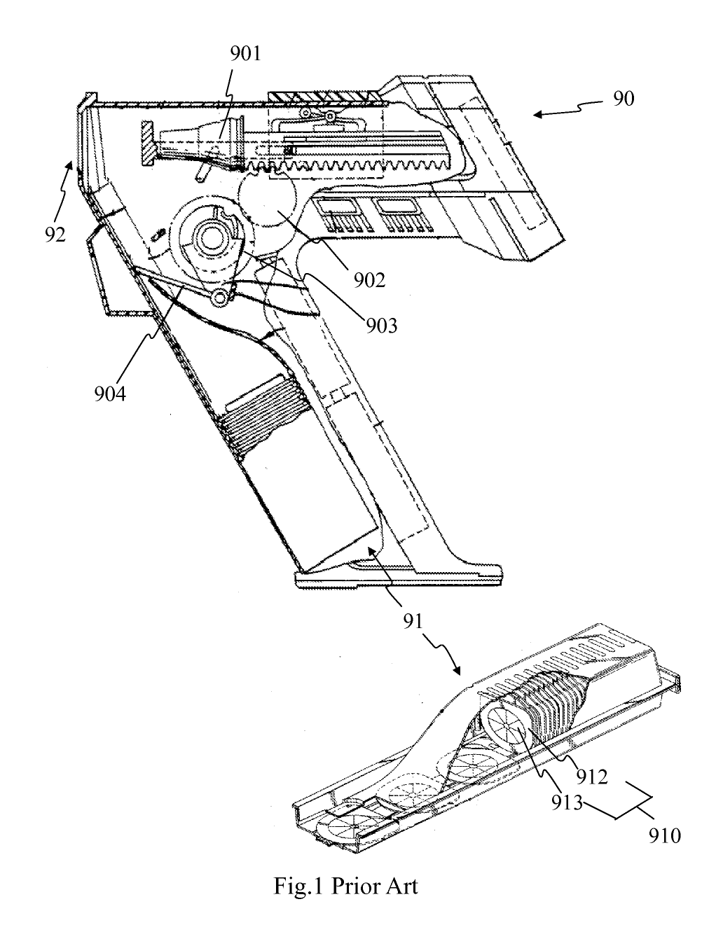

FIG. 2A is a side perspective view of a first embodiment of a partial physiological signal sensing device in accordance with the present invention;

FIG. 2B is a side perspective view of the partial physiological signal sensing device referring to FIG. 2A showing that a sensing module being moved toward an opening till the sensing module disconnects with a driving assembly;

FIG. 2C is a side perspective view of a partial physiological signal sensing device referring to FIG. 2A showing that the sensing module being moved over a predetermined site;

FIG. 2D is a side perspective view of a partial physiological signal sensing device referring to FIG. 2A showing that the sensing module is moved rearwards away from the opening to connect with the driving assembly;

FIG. 3A is a schematic structure view of a partial physiological signal sensing device referring to FIG. 2A showing that the sensing module being moved toward a predetermined site;

FIG. 3B is a schematic structure view of a partial physiological signal sensing device referring to FIG. 2A showing that the sensing module being moved at the predetermined site;

FIG. 3C is a schematic structure view of a partial physiological signal sensing device referring to FIG. 2A showing that the sensing module being moved over the predetermined site;

FIG. 3D is a schematic structure view of a partial physiological signal sensing device referring to FIG. 2A showing that the sensing module is moved rearwards away from the opening;

FIG. 4 is a flow chart of a method for transporting a protective film of a physiological signal sensing device in accordance with the present invention;

FIG. 5 is a schematic structure view of the second embodiment of a partial physiological signal sensing device in accordance with the present invention;

FIG. 6A is a schematic structure view of a third embodiment of a partial physiological signal sensing device in accordance with the present invention showing that the sensing module is moved before a predetermined site;

FIG. 6B is a schematic structure view of a partial physiological signal sensing device referring to FIG. 6A that the sensing module is moved over the predetermined site;

FIG. 7 is a side perspective view of the forth embodiment of a partial physiological signal sensing device in accordance with the present invention; and

FIG. 8 is an enlargement view of a protective-film containing assembly referring to FIG. 7.

### DESCRIPTION OF THE PREFERRED EMBODIMENTS

For the purposes of promoting an understanding of the principles of the invention, reference will now be made to the embodiment illustrated in the drawings, and specific language will be used to describe that embodiment. It will nevertheless be understood that no limitation of the scope of the invention is intended. Alterations and modifications in the illustrated device, and further applications of the principles of the invention as illustrated therein, as would normally occur to one skilled in the art to which the invention relates are contemplated, are desired to be protected. Such alternative embodiments require certain adaptations to the embodiments discussed herein that would be obvious to those skilled in the art.

The following description and accompanying drawings are some examples in accordance with the present invention. The same symbol herein in the drawings indicates the same or similar structure.

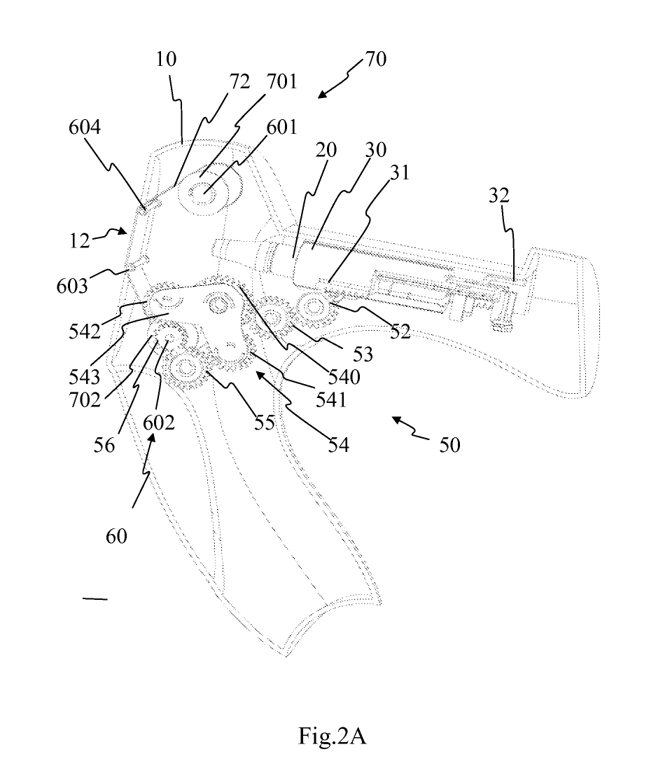

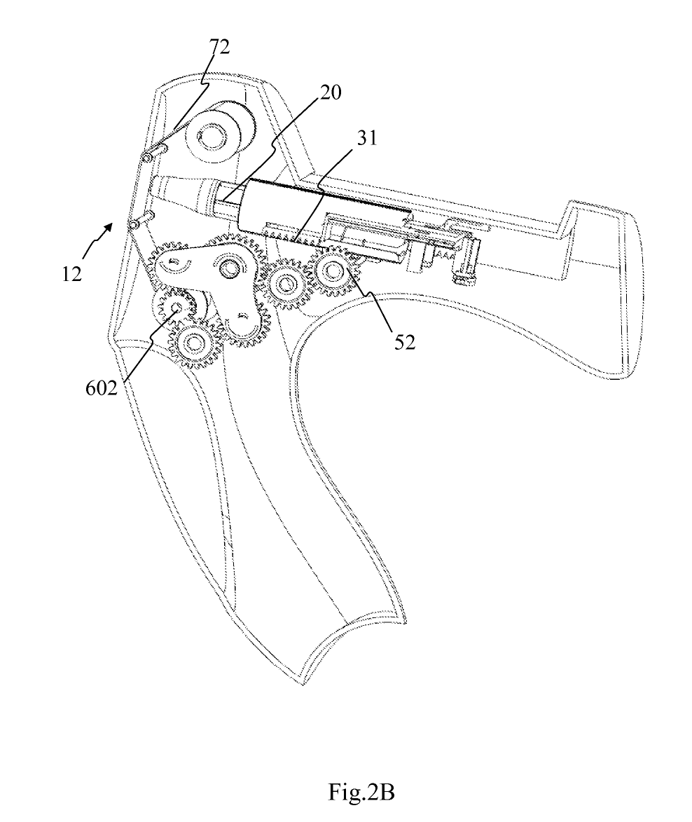

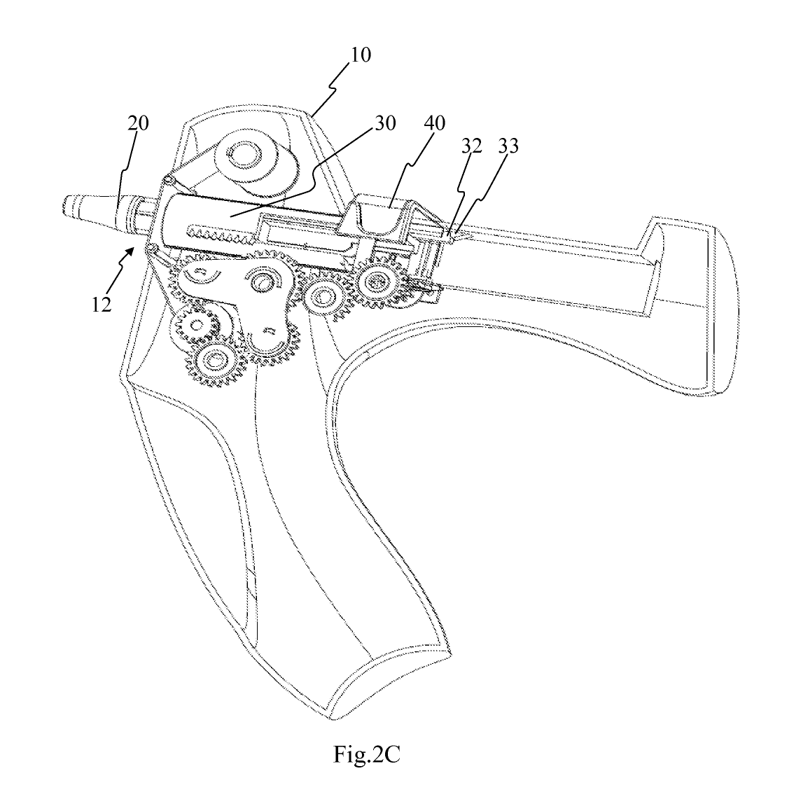

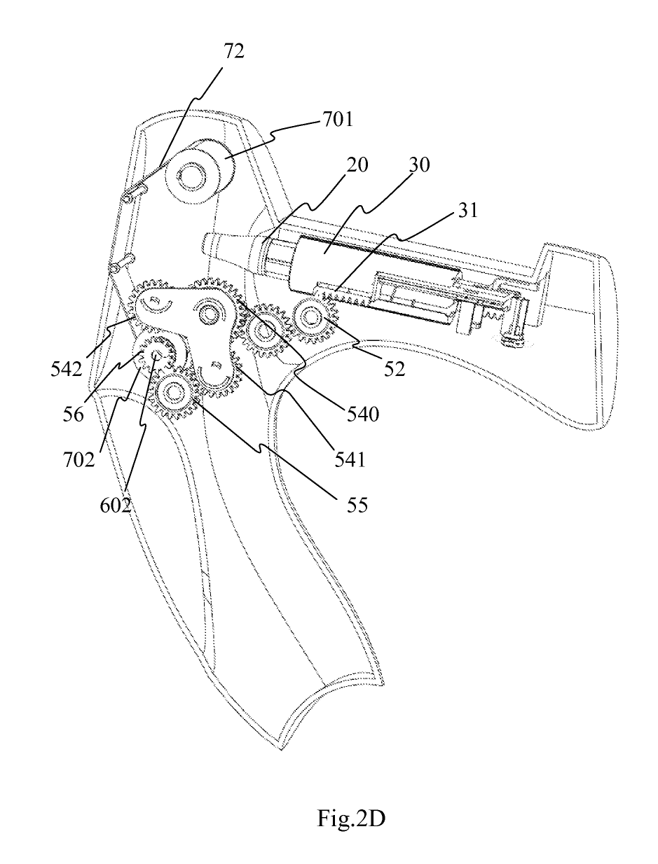

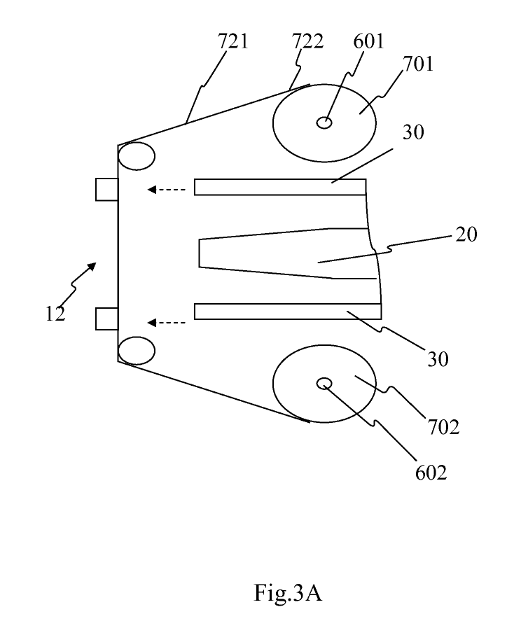

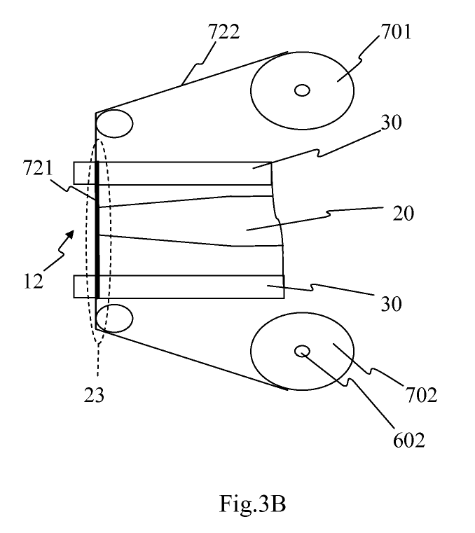

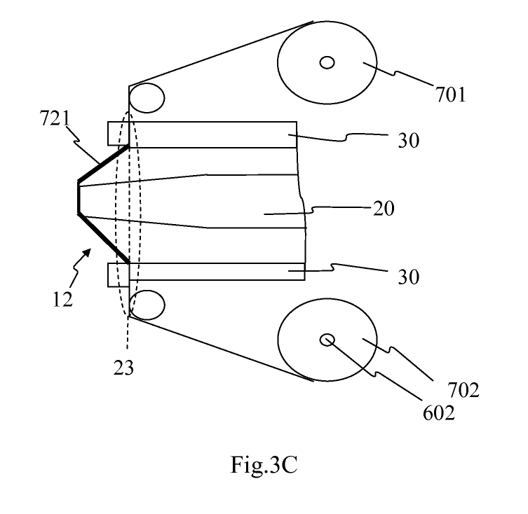

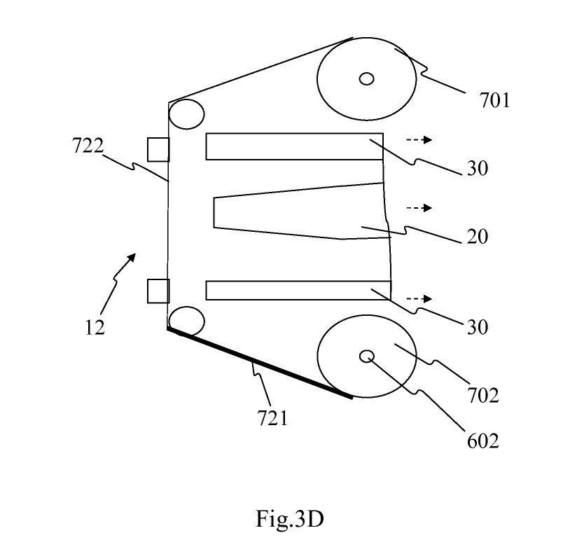

A first embodiment of the present invention refers to FIGS. 2A to 2D, and FIGS. 3A to 3D.

Please refer to both FIGS. 2A and 2C first. FIG. 2A is a partial side perspective view of the first embodiment of a physiological signal sensing device in accordance with the present invention. FIG. 2C is a side perspective view showing that a sensing module of the physiological signal in FIG. 2A being moved across a predetermined site.

The physiological signal sensing device comprises a housing (10), a sensing module (20), a fastening (30), a controller (40), a driving assembly (50), a transporter (60), a protective-film containing assembly (70) and a protective film (72). FIG. 2A ignores some parts of the fastening (30) and controller (40) at front end surrounding the sensing module (20) in order to mark the location of the sensing module (20) and so does in FIGS. 2B and 2D.

The housing (10) includes an opening (12). The sensing module (20) herein is an ear thermometer fixedly engaged within the housing (10).

The fastening (30), a follower (31) and the controller (40) are disposed at outer part of the sensing module (20)

Please further referring to FIG. 2C first, a part of the controller (40) is disposed outside the housing (10) and another part of the controller (40) mounted into the housing (10) to connect with the sensing module (20) for providing a holding site. The controller (40) is moved along a hollow channel formed alongside the housing (10) and is extended from a side of the sensing module (20) and out of the housing (10). Whereby, users are able to move the sensing module (20) by moving the controller (40) along the channel. The controller (40) can also be designed other structure as needed, such as in another embodiment that the controller (40) can be designed as an extending part from a back end of the sensing module (20) and extended out from the back end of the housing (10) to provide a site to press.

Now referring back to FIG. 2A, the sensing module (20) is surrounded by the fastening (30). More specifically, the fastening (30) is movably engaged with the sensing module (20) by a connector. The connector in this embodiment of the present invention is a spring. In other embodiments of the present invention, it can also be connected by any selected connector as needed, such as a gear or wheel. When the sensing module (20) is moved forward to the opening (12), the fastening (30) is driven by the sensing module (20) to move toward the opening (20) so as to be able to fix an area of the protective film (72) at the opening (12).

The follower (31) is disposed at an outer site relative to the sensing module (20). More specifically, the follower (31) is disposed at one side of the fastening (30) and indirectly connects the sensing device (20) and the driving assembly (50).

Please now referring to both FIGS. 2A and 2C, the physiological signal sensing device of the embodiment in accordance with the present invention further includes an immobilizing assembly. The immobilizing assembly can be designed as a coupling assembly such as an assembly with a protrusion and a corresponding depression. In this embodiment, the immobilizing assembly is designed as two protrusions (32, 33). The protrusion (32), shown in FIG. 2A, is disposed on the sensing module (20). Another protrusion (33), shown in FIG. 2C, is disposed at an inner side of the housing (10) at the moving path that the sensing module (20) moved along.

Now referring back to FIG. 2A, the driving assembly (50) of the embodiment is a gear assembly including gears (52, 53, 54, 55 and 56). The gear (52) is able to connect with the follower (31) so as to be driven by the motion of the sensing module. The gear (54) comprises connecting gears (540, 541, 542) and a connecting member (543). The connecting member (543) connects each axle center of connecting gears (540, 541, 542) so as to form gear (54) which can be changed in its connection situation by operation. The gear (53) is connected between the gear (52) and the connecting gear (540). By the motion forward to the opening or rearward away from the opening of the sensing module (20) can the connecting gear (541) be indirectly driven to engage with the gear (55), or selectively can the connecting gear (542) be indirectly driven to engage with the gear (56). While the connecting gear (541) is engaged with the gear (55), the connecting gear (542) is disengaged with the gear (56). In contrast, while the connecting gear (541) is disengaged with the gear (55), the connecting gear (542) engaged with the gear (56). Whereby, the driving assembly (50) is switchable to drive the transporter (60) to move.

The transporter (60) may comprise one or more transporting members for transporting the protective film (72). In this embodiment, the transporter comprises transporting members (601, 602, 603, 604) and each of them is a columned rotatable structure. The protective film (72) can be transported by the rotation of transporting members (601, 602, 603, 604).

The protective-film containing assembly (70) includes a containing portion (701) and an accepting portion (702). The transporting members (601, 602) respectively connect with the containing portion (701) and the accepting portion (702). The transporting members (603, 604) are respectively disposed at two sides of the opening (12). The accepting portion (702) can be rotated by the rotation of the transporting member (602). The rotation of the accepting portion (702) can drive the protective film (72) to move so as to drive the transporting members (601, 603, 604) to rotate and whereby the transporting members (601, 603, 604) transport the protective film (72) to pass across the opening (12) in a direction from the containing portion (701) toward the accepting portion (702).

The driving assembly (50) in this embodiment includes multiple gears (52, 53, 54, 55, 56) for driving the transporter (60) to transport protective film (72) from the containing portion (701) to the accepting portion (702). However, the present invention should not be limited. The driving assembly can be designed as needed. In another embodiment for example, it can be designed that the sensing module (20) is directly connected with the gear (54) without gears (52, 53).

To describe more specific about the operation process of the first embodiment in accordance with the present invention, please refer to both FIGS. 2A and 3A first. FIG. 3A is a schematic structure view of a portion of the physiological signal sensing device referring to FIG. 2A showing that the sensing module being moved toward a predetermined site.

Please first refer to FIG. 3A, when the sensing module (20) is moved toward to the opening (12), the fastening (30) is also moved toward the opening (12) following with the sensing module (20). Then refer to FIG. 2A, after the sensing module (20) is moved till the follower (31) connects with the gear (52), the motion of the sensing module (20) drives a series action process of the gear set.

First, the gear (52) rotates in counterclockwise direction so as to indirectly drive the connecting gear (540) to rotate in counterclockwise direction. The force of the rotation of the connecting gear (540) can drive the connecting member (543) to rotate in counterclockwise direction so as to have the connecting part which connects the connecting member (543) and the connecting gear (542) to move downward so as to have the connecting gear (542) connect the gear (56) and have the connecting gear (541) separated from the gear (55). By keeping rotating the gear (540) will drive the connecting gear (542) to rotate in clockwise direction so as to drive the gear (56) and the transporting member (602) to rotate in counterclockwise direction. Whereby, the transporter (60) can transports the protective film which has multiple areas includes area (721) and area (722) from the containing portion (701) to the accepting portion (702).

Then, pleas refer to FIG. 2B. FIG. 2B is a side perspective view of a partial physiological signal sensing device referring to FIG. 2A showing that the sensing module being moved toward an opening till the sensing module disconnects with the driving assembly.

After the sensing module (20) keeps being moved toward the opening (12) till the follower (31) disconnect with the gear (52) as FIG. 2B shown, the transport member (602) won't be driven by the sensing module (20) so as not to transport the protective film. As a result, the protective film stops moving. Then refer to FIG. 3B, FIG. 3B is a schematic structure view of a partial physiological signal sensing device referring to FIG. 2A showing the sensing module being moved to the predetermined site. When the sensing module (20) keeps being moved to a predetermined site (23) showed in dotted line, the fastening (30) is driven by the sensing module (20) to move to the predetermined site (23) so as to fix the area (721) at the opening (12).

Please refer to FIG. 3C, FIG. 3C is a schematic structure view of a partial physiological signal sensing device referring to FIG. 2A that the sensing module being moved over the predetermined site. When the sensing module (20) keeps being moved over the predetermined site (23) and passing through the opening (12), the area (721) is fixed and stretched over the sensing module (20) by the force from the fastening (30) and the sensing module (20). Due to the area (721) evenly covering the sensing module (20), the interference of temperature sensing from the protective film can be decreased.

Refer to FIG. 2C, after a part of the protect film (72) is stretched over the sensing module (20) (figure not shown) by moving the sensing module (20), the protrusion (32) is also moved with the motion of the sensing module (20) to couple with the protrusion (33), and therefore the sensing module can be immobilized. Therefore, user does not need to provide force to maintain the situation that the protective film covering over the sensing module. Whereby, it can increase convenience while using. When the protrusion (32) is decoupled from the protrusion (33), then it may have the sensing module (20) turn back as a movable one.

Please now refer to both FIGS. 2D and 3D. FIG. 2D is a side perspective view of the physiological signal sensing device referring to FIG. 2A showing that the sensing module is moved rearwards away from the opening to connect with the driving assembly. FIG. 3D is a schematic structure view of a partial physiological signal sensing device referring to FIG. 2A that the sensing module is moved rearwards away from the opening.

Please refer to FIG. 3D first, when the sensing module (20) is moved rearward away from the opening (as arrow shown), the fastening (30) is also moved rearward following with the motion rearward of the sensing module (20).

Refer to FIG. 2D, when the sensing module (20) is move rearwards till the follower (31) connects with the gear (52) again and then keeps being moving rearwards so as to drive the gear set with series action.

The gear (52) is driven by the motion of the follower (31) to rotate in clockwise direction. The rotation of the gear (52) indirectly drives the connecting gear (540) to rotate in the same direction. The rotation force have the connecting member (543) to rotate in clockwise so as to have the portion which connect the connecting member (543) and the connecting gear (541) to move a little bit to the left. Whereby, the connecting gear (541) can connect with the gear (55) and the connecting gear (542) disconnect with the gear (56).

While the sensing module (20) keeps being moved, the gear (55) will be driven to rotate in clockwise direction. The rotation of the gear (55) drives the gear (56) to rotate in counterclockwise direction so as to drive the transporting member (602) to rotate in counterclockwise direction. Whereby, the transporter (60) transports the protective film (72) from the containing portion (701) to the accepting portion (702).

By means of the acting process described above referring to FIG. 2D, the area (722) referring in FIG. 3D is transported to the moving path which the sensing module (20) is moved toward the opening (12) and replace the area (721). The area (721) then is transported toward the accepting portion (702). By means of the driving assembly (50), whether the sensing module (20) is moved forward or backward or not, the protective film (72) can be transported. Hence, by the time the used area of protective film (72) is transported away from the opening (12), a new one is transported to the opening (12) in order to not only avoid using the used area by user but also efficiently use the moving distance of the sensing module (20) to move an area of an unused protective film to the opening (12).

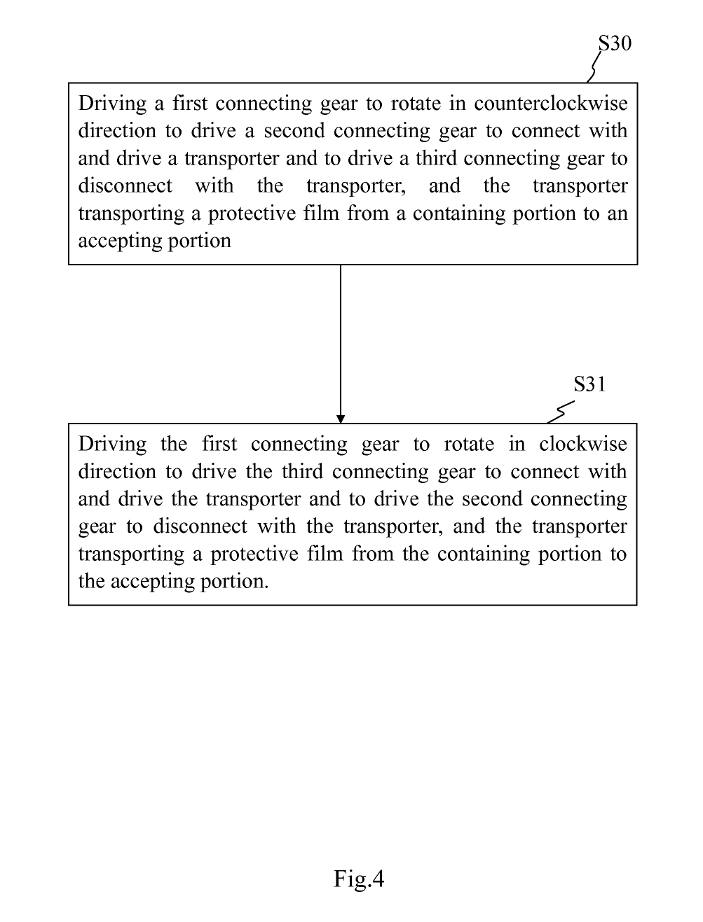

In addition, please refer to FIGS. 3A to 3D and 4. FIG. 4 is a flow chart of a method for transporting a protective film of a physiological signal sensing device in accordance with the present invention.

In this embodiment, when the sensing module (20) is moved toward the opening (20), then the driving assembly (50) will be driven so as to enter step (S30) referring to FIG. 4 by the sensing module. Firstly, it will drive a connecting gear (540) to rotate in counterclockwise direction so as to drive a connecting gear (542) to connect with the transporting member (602) and so as to drive a connecting gear (541) to disconnect with the transporting member (602), and the rotation of the connecting gear (542) can drive the transporting member (602) to transport a protective film (72) from the containing portion (701) to the accepting portion (702). When the sensing module (20) is moved rearwards away from the opening (12) till it connects with the driving assembly (50), then the driving assembly (50) will be driven again so as to enter the step (S31) referring to FIG. 4. It will drive the connecting gear (540) to rotate in clockwise direction so as to drive the connecting gear (541) to connect with the transporting member (602) and drive the connecting gear (542) to disconnect with the transporting member (602), and the rotation of the connecting gear (541) will drive the transporting member (602) to transport protective film (72) from the containing portion (701) to the accepting portion (702).

Besides, the motion toward the opening (12) and rearwards away from the opening of the sensing module (20) drive the transporter (60) to transport protective film (72) from the containing portion (701) to the accepting portion (702) so as to not only move the used area of the protective film away from the opening to avoid second use but also efficiently use the moving distance of the sensing module for transporting an area of the protective film to the opening perfectly.

In addition, the physiological signal sensing device comprises a fastening (30) which can have the protective film (72) properly fixed and stretched over the sensing module (20). Therefore, the physiological signal sensing device with a fastening can prevent interference of sensing due to the protective film unevenly covers the sensing module.

Although possible types of physiological signal sensing device and methods for transporting a protective film in accordance with the present invention have been described in the embodiment above, those skilled in the art shall recognized that different physiological signal sensing devices and methods for transporting a protective film can be designed. Therefore, the spirit of the present invention shall not be limit to these possible types of physiological signal sensing device and methods for transporting a protective film in accordance with the present invention. In other words, a device or a mechanism that using a first structural member of a driving assembly driven by a apparatus so as to drive one of a second structural member and a third structural member of the driving assembly to selectively connects to a transporter of the device to transporting a protective film from a starting site to an ending site is the key spirit and scope of the present invention. The followings are some other embodiments in accordance with the present invention for those skilled in the art to know more about the spirit of the present invention.

The sensing module (20) connects to the gear (52) so as to drive the transporting member (602) to operate in the above embodiment referring to FIG. 2A, in other embodiment (not shown in the figure), it can be designed that the sensing module (20) directly connects with the connecting gear (540).

In the first embodiment, the connecting gears (541, 542) selectively connect with the transporting member (602). It can also use other member to connect the connecting gear (541) to the transporting member (602), for example, it can be designed an extra gear connected between the connecting gear (540) and the connecting gear (542). In this way, when the connecting gear (540) rotates in a clockwise direction, the connecting gear (541) rotates in a counterclockwise direction. When the connecting gear (540) rotates in a counterclockwise direction, the connecting gear (542) also rotates in a counterclockwise direction. Whereby, the connecting gear (541, 542) can directly connect to the transporting member (602) without the gear (55).

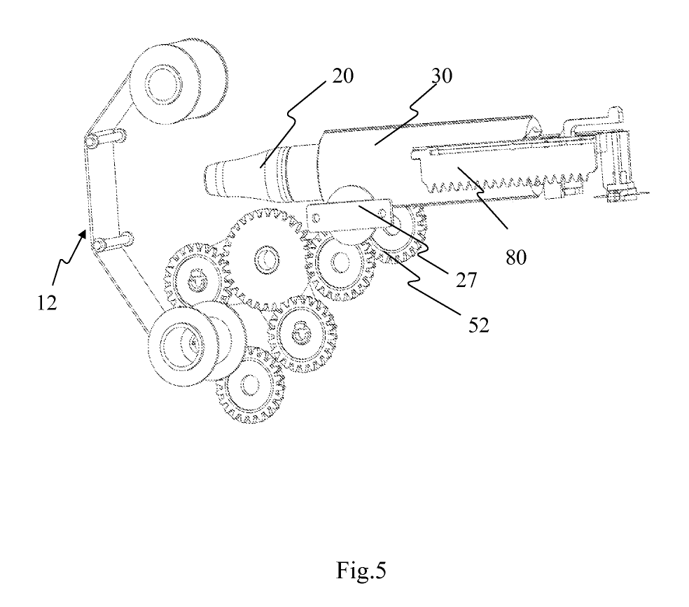

Please refer to both FIGS. 2A and 5, FIG. 5 is a schematic structure view of a second embodiment of a physiological signal sensing device in accordance with the present invention. The physiological signal sensing device of the embodiment further comprises a resistant (27) and a following (80) disposed at opposite side relative to the gear (52) and the follower (31) as in FIG. 2A. In another embodiment, the resistant (27) can be disposed at the same side as the gear (52) and the driving assembly (50) is shown in FIG. 2A and connect with the follower (31) referring to FIG. 2A so as to drive it by the follower (31). In this embodiment, when the sensing module (20) is moved toward the opening (12) till the following (80) is engaged with the resistant (27) and then the sensing module (20) keeps being moved, the resistant (27) forms a resisting force against the motion force from the sensing module (20). Whereby, the effect of the motion force from the sensing module (20) can be cushioned. The resistant (27) can be designed as needed for providing a resisting force such as spring. In this embodiment, the resistant is a damper.

By the resisting force formed from the resistant (27), the motion force from the sensing module (20) can be cushioned effectively in case that the motion force of the sensing module (20) is too large to break the protective film while the sensing module (20) being moved though the opening (12).

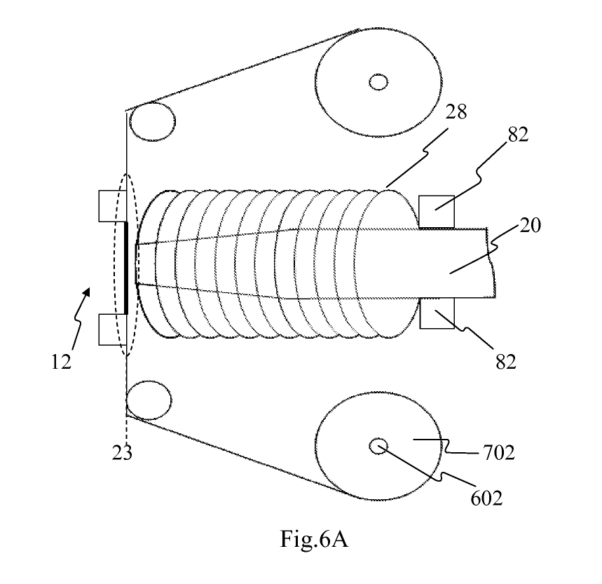

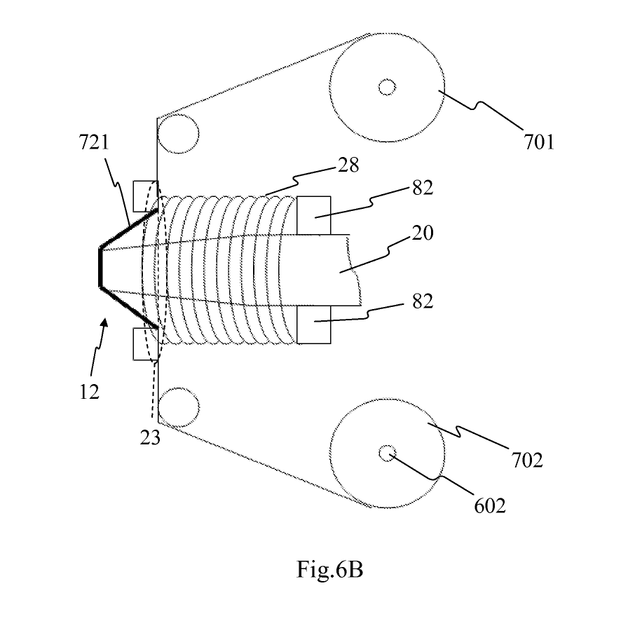

Please now refer to FIGS. 6A and 6B, FIG. 6A is a schematic structure view of a third embodiment of a physiological signal sensing device in accordance with the present invention showing that the sensing module is moved before a predetermined site. FIG. 6B is a schematic structure view of the physiological signal sensing device referring to FIG. 6A showing that the sensing module is moved over the predetermined site.

Please refer to FIGS. 2A, 5 and 6A. The physiological signal sensing device of this embodiment works similar to the first embodiment. The difference is that the resistant is an elastic member (28). The elastic member (28) connects with the following (82). In another embodiment, the following (82) can be designed as a part extended out from the sensing module (20). The elastic member (28) has both the function of the fastening (30) referring to FIG. 2A and the function of the resistant (27) referring to FIG. 5. The elastic member (28) is a spring surrounding the sensing module (20).

Referring to FIG. 6B, when the sensing module (20) is moved to a predetermined site (23) and keeps being moved over the predetermined site (23) and then moved through the opening (12). The elastic member (28) is compressed by the following (82) and forms an elastic potential energy to form a force to the area (721) so as to have the area (721) fixed at the opening (12). In addition, the elastic member (28) also forms a resisting force against the motion force of the sensing module (20) so as to cushion the motion force from the sensing module (20).

Therefore, by means of the elastic member (28) of the embodiment, the function of properly fixing the protective film, having the protective film evenly stretched over the sensing module and preventing the protective film from broken can be reached.

Please further referring to FIGS. 2C, 6A and 6B preferably, an immobilizing assembly referring to FIG. 2C is disposed as shown in this embodiment. When the protrusion (32) is coupled to the protrusion (33) to immobilizing the sensing module (20), the sensing module (20) is not moved back ward due to the resisting force of the elastic member. Whereby, the protective film can maintain the situation which evenly stretched over the sensing module (20) without keeping providing a force to the sensing module by users.

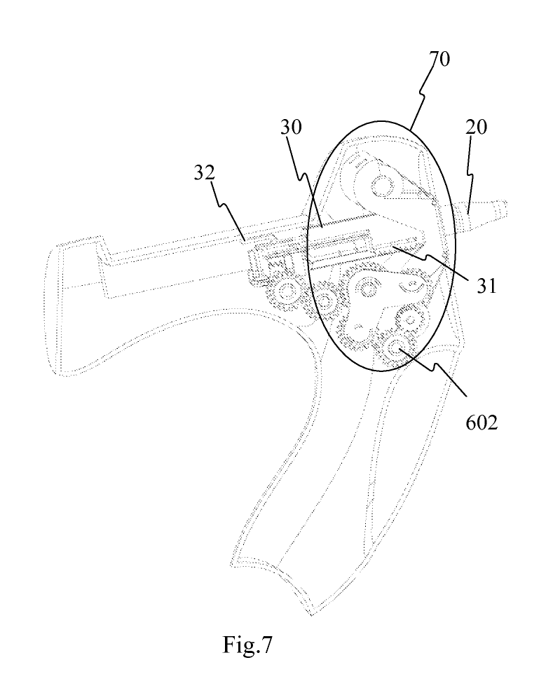

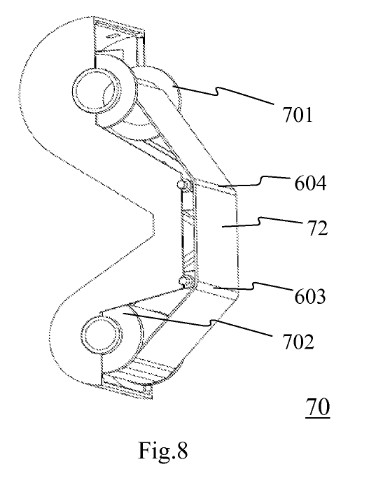

The protective-film containing assemblies in the embodiments described above are fixed within the physiological signal sensing device. However, the present invention should not be limited with it; the protective-film containing assembly can also be a detachable device. Please refer to FIGS. 7 and 8. FIG. 7 is a side perspective view of a forth embodiment of a physiological signal sensing device in accordance with the present invention. FIG. 8 is an enlargement view of a protective-film containing assembly referring to FIG. 7.

Please first refer to FIGS. 2A, 2C and 7, the physiological signal sensing device of the embodiment comprises a transporting member (602), a sensing module (20), a fastening (30), a driving assembly (50), a follower (31) and protrusions (32, 33) as in the first embodiment referring to FIGS. 2A and 2C. Referring to FIG. 7, the physiological signal sensing device of the embodiment further comprises a detachable protective-film containing assembly (70), which comprises a containing portion (701), an accepting portion (702) and transporting members (601, 603, 604). Comparing to the transporting device of the first embodiment, the transporting member (602) is fixedly disposed within the housing (10) in this embodiment. The transporting members (601, 603, 604) are disposed within the protective-film containing assembly (70). After the protective-film containing assembly (70) is equipped in the housing (10), the accepting portion (702) connects with the transporting member (602) so as to be driven by the sensing module (20), whose acting process as in the first embodiment. Users can easily change protective film by using the detachable protective-film containing assembly (70).

The sensing module in the first embodiment is fixedly disposed within the housing referring to FIG. 2A. However, it can also be designed as a detachable one. Hence, the sensing module adapted to the specific physiological signal sensing device can be designed for sensing other physiological signal besides ear temperature. Users can pick up a specific sensing module for detecting specific physiological signal as needed. In the above embodiments, the fastening (30) or the elastic member (28) is disposed surround the sensing module. However, the fastening (30) or the elastic member (28) can be disposed in other way as needed such as disposed at one side or two sides of the sensing module.

In the first embodiment, the fastening (30) is driven by the sensing module (20). However, the fastening (30) can be designed as an independent device that operate independently. In another embodiment of the present invention, for example, the fastening (30) may be disposed at the side next to the opening and does not connect with the sensing module. When the fastening (30) is driven by a force, the protective film will be fixed by the fastening at the opening, whereas the sensing module is driven by another force and pass through the opening.

In the first embodiment, the sensing module (20) is an IR ear thermometer. However, it can also be designed as other sensing module that detect other physiological signals such as body temperature, forehead temperature, the size of pores in skin, humidity of skin or the image detected by ultrasonic system.

In the first embodiment of the present invention, a sensing module is disposed within the housing. In another embodiment, the sensing module of the physiological signal sensing device in accordance with the present invention can be replaced by a container for containing other member as needed such as different sensing module or a hard structure member and the whole device here is regarded as a containing device. For example, the container may contain a hard plastic structure member; the protective film may be designed for electrostatic dust collection. Whereby, this containing device can be used as a portable cleaning device for cleaning small and tiny places and the used part of the film can be changed with hand contacting.

Accordingly, the physiological signal sensing device or the containing device transports a protective film from a starting site to an ending site by the motion forward to an opening or rearwards away from the opening of a sensing module of the physiological signal sensing device or a container of the containing device. Whereby, an area of the protective film can be fully transported to the opening with decrease of the length of moving path of the sensing module or the container. Furthermore, there are also other advantages in some embodiments of the present invention exemplarily listed as follows:

a. The physiological signal sensing device or the containing device comprises a fastening that can have a protective film properly fixed and stretched over the sensing module or the container.

b. The physiological signal sensing device or containing device in accordance with the present invention comprises an immobilizing assembly which can make the protective film keep being stretched and evenly cover the sensing module or a container without users keeping providing force.

c. The physiological signal sensing device or the containing device comprises a resistant which may prevent the protective film from breaking.

d. The physiological signal sensing device or the containing device comprising an elastic member regarded as a fastening and a resistant which may reach both function of points a and c described above.

Other embodiments of the invention will appear to those skilled in the art from consideration of the specification and practice of the invention disclosed herein. It is intended that the specification and examples to be considered as exemplary only, with a true scope and spirit of the invention being indicated by the following claims.

What is claimed is:

1. A physiological signal sensing device comprising:
a sensing module for sensing a vital signal;
a transporter for transporting a protective film from a starting site to an ending site; and
a driving assembly comprising
a first structural member, connected with said sensing module;
a second structural member; and
a third structural member, one of said second structural member and said third structural member selectively connected to said transporter depending on a rotation direction of said first structural member; and said first structural member, said second structural member and said third structural member driven to rotate by one another;
when said sensing module drives said first structural member to rotate in a first direction, said first structural member drives said second structural member to connect with said transporter and drives said third structural member to disconnect with said transporter, and a rotation of said second structural member drives said transporter to transport said protective film from said starting site to said ending site; when said sensing module drives said first structural member to rotate in a second direction, said first structural member drives said third structural member to connect with said transporter and drives said second structural member to disconnect with said transporter, and a rotation of said third structural member drive said transporter to transport said protective film from said starting site to said ending site.

2. The physiological signal sensing device of claim 1, further comprising a connecting member connecting with said first structural member, said second structural member and said third structural member so as to have the connection of each axle center of said first structural member, said second structural member and said third structural member form as a triangular shape.

3. The physiological signal sensing device of claim 1, further comprising a rotating member connected between said first structural member and said third structural member, or connected between said third structural member and said transporter for having the transporting direction of said transporter be the same.

4. The physiological signal sensing device of claim 1, further comprising a follower connected between said sensing module and said driving assembly to drive said driving assembly to operate by a motion of said sensing module.

5. The physiological signal sensing device of claim 1, further comprising a controller disposed on said sensing module and extended out from said physiological signal sensing device for providing a holding site to movably move said sensing module.

6. The physiological signal sensing device of claim 1, further comprising a fastening connecting with said sensing module for fixing said protective film at an opening of the physiological signal sensing device.

7. The physiological signal sensing device of claim 1, further comprising a resistant connected with said sensing module for forming a resisting force against the motion of said sensing module.

8. The physiological signal sensing device of claim 7, further comprising an immobilizing assembly connected with said sensing module; after said sensing module is moved till said protective film is stretched over said sensing module, said immobilizing assembly is fixed at a predetermined position to maintain a situation that said protective film being stretched over said sensing module.

9. The physiological signal sensing device of claim 1, further comprising a protective film-containing device engaged with said transporter for containing said protective film.

10. A containing device comprising:
a container for providing a containing space;
a transporter for transporting a protective film from a starting site to an ending site; and
a driving assembly comprising
a first structural member, connected with the container;
a second structural member; and
a third structural member, one of said second structural member and said third structural member selectively connected to said transporter depending on a rotation direction of said first structural member; and said first structural member, said second structural member and said third structural member driven to rotate by one another;
when said container drives said first structural member to rotate in a first direction, said first structural member drives said second structural member to connect with said transporter and drives said third structural member to disconnect with said transporter, and a rotation of said second structural member drives said transporter to transport said protective film from said starting site to said ending site; when said container drives said first structural member to rotate in a second direction, said first structural member drives said third structural member to connect with said transporter and drives said second structural member to disconnect with said transporter, and a rotation of said third structural member will drive said transporter to transport said protective film from said starting site to said ending site.

11. The containing device of claim 10, further comprising a connecting member connected with said first structural member, said second structural member and said third structural member to have the connection of each axle center of said first structural member, said second structural member and said third structural member form as a triangular shape.

12. The containing device of claim 10, further comprising a rotating member connected between said first structural member and said third structural member, or connected between said third structural member and said transporter for having the transporting direction of said transporter be the same.

13. The containing device of claim 10, further comprising a follower connected between said container and said driving assembly to drive said driving assembly to operate by a motion of said container.

14. A containing device for containing a protective film and adapted for a physiological signal sensing device including a driving assembly, a transporter and a sensing module, said containing device comprising:
a containing portion for containing a protective film; and
a accepting portion for accepting said protective film from said containing portion and engaged with said transporter,
wherein said driving assembly includes a first structural member, a second structural member and a third structural member; and said first structural member connects with said container; one of said second structural member and said third structural member selectively connects to said transporter depending on a rotation direction of said first structural member; said first structural member, said second structural member and said third structural member are driven to rotate by one another; when said sensing module drives said first structural member to rotate in a first direction, said first structural member drives said second structural member to connect with and drive said transporter and drives said third structural member to disconnect with said transporter, and said transporter transports said protective film from said containing portion to said accepting portion; when said sensing module drives said first structural member to rotate in a second direction, said first structural member drives said third structural member to connect with and drive said transporter and drives said second structural member to disconnect with said transporter, and said transporter transports said protective film from said containing portion to said accepting portion.

15. A method for transporting a protective film, which is adapted for a transporter that is engaged with a first structural member, a second structural member, and a third structural member, said method comprising:
driving said first structural member to rotate in a first direction to drive said second structural member to connect with and drive said transporter and to drive said third structural member to disconnect with said transporter, and said transporter transporting said protective film from a starting site to an ending site, wherein said first structural member, said second structural member and said third structural member are driven to rotate by one another; and
driving said first structural member to rotate in a second direction to drive said third structural member to connect with and drive said transporter and to drive said second structural member to disconnect with said transporter, and said transporter transporting said protective film from said starting site to said ending site.

16. A method for transporting a protective film, which is adapted for a physiological signal sensing device comprising a sensing module for sensing a vital signal, a transporter for transporting a protective film, and a driving assembly including a first structural member, a second structural member, and a third structural member, said method comprising:
driving said first structural member to rotate in a first direction by said sensing module to drive said second structural member to connect with and drive said transporter and to drive said third structural member to disconnect with said transporter, and said transporter transporting said protective film from a starting site to an ending site, wherein said first structural member, said second structural member and said third structural member are driven to rotate by one another; and
driving said first structural member to rotate in a second direction by said sensing module to drive said third structural member to connect with and drive said transporter and to drive said second structural member to disconnect with said transporter, and said transporter transporting said protective film from said starting site to said ending site.
